(19) United States
(12) Patent Application Publication
(10) Pub. No.: US 2020/0001259 A1
(43) Pub. Date: Jan. 2, 2020

(54) SPARGE FOR A HIGH-PRESSURE VESSEL

(71) Applicant: PROCESS PLANTS INTERNATIONAL PTY LTD, Subiaco, Western Australia (AU)

(72) Inventor: Daniel FISHER, Subiaco, Western Australia (AU)

(73) Assignee: PROCESS PLANTS INTERNATIONAL PTY LTD, Subiaco, Western Australia (AU)

(21) Appl. No.: 16/489,247

(22) PCT Filed: Feb. 28, 2018
(86) PCT No.: PCT/AU2018/050179

§ 371 Date: Aug. 27, 2019

(30) Foreign Application Priority Data
Feb. 28, 2017 (AU) 2017900687

(51) Int. Cl. B01F 15/00; B01F 15/02

(52) U.S. Cl. CPC B01F 15/00863; B01J 4/004; B01F 15/0203

(57) ABSTRACT

A sparge for use in a high-pressure vessel operated at elevated temperatures and having high energy agitators for suspending mineral containing particles in a slurry. The sparge injects reagent fluids into the slurry to reduce reaction times and for controlling process parameters for extracting valuable minerals from the particles. The sparge has a vapour lock to inhibit the flow of particulate material and detritus material under low or no fluid flow situations which occur commonly in the operation of high pressure autoclaves. The sparge has a fluid flow path that increases in cross-sectional area in the direction of flow of reagent fluids so as to keep reagent fluids flowing at a velocity below a critical impingement velocity that can cause metal materials of the sparge to either wear rapidly, combust and in the worst case lead to loss of containment and violent and rapid depressurisation of the highpressure vessel.

### CROSS-REFERENCE TO RELATED APPLICATION

This application is the U.S. national phase of PCT Application No. PCT/AU2018/050179 filed on Feb. 28, 2018, which claims priority to AU Patent Application No. 2017900687 filed on Feb. 28, 2017, the disclosures of which are incorporated in their entirety by reference herein.

### FIELD OF THE INVENTION

The present invention relates to a sparge fora high-pressure vessel or autoclave.

More particularly, the present invention relates to a sparge including a vapour lock means to substantially prevent backflow of slurry materials into the sparge when used in a high-pressure vessel or autoclave. The vapour lock means substantially prevents the sparge blocking from solids settling due to gravity during low fluid flow and no flow (process/production hold) operation.

### TERMINOLOGY

In the context of the present invention the following terminologies are used:

“Agitator” means a high energy stirrer typically disposed vertically downward, upwardly or horizontally disposed in a pressure vessel reaction chamber for stirring a slurry of ore bearing material.

“Autoclave” means a horizontal or vertical high-pressure reaction vessel of the type typically used in high pressure leaching processes. Such autoclaves use agitators rather than sparges to maintain solids in liquid suspension. Autoclaves are three phase devices whereas fluidized bed reactors are two phase devices. Such autoclaves are used to facilitate and speed up reactions between the phases to extract valuable minerals. Such autoclaves must be operated in a way so as to avoid combustion and/or explosion of any of the phases in the autoclave—because any combustion is dangerous and can lead to the destruction of processing plant equipment and injury or death of nearby operators.

“Bubble cap” means a device usually in the form of a metal cup, with notches or slots around its edge, that is inverted over a hole in a plate in a bubble tower for effecting contact of fluids rising from below the plate into a liquid already on top of the plate. Bubble caps are low pressure devices usually used in two-phase fluidized bed reactors. Typically, hundreds of bubble caps are used in a reactor to fluidize a solid phase within a gas phase (or a solid phase within a liquid phase) to achieve the desired contact between the two phases of the reactor

“Elevated temperature” means temperatures between 100 C and 300 C, and more particularly temperatures between 150 C and 250 C. This is different from high temperature operation, over 500 C (more typically over 1,000 C), which is commonly used in fluidized bed reactors for burning or oxidizing one phase within another phase.

“Fluid” means any substance capable of flow and having no fixed shape and includes gases (such as steam or oxygen), liquids (such as water, acid or alkali) and slurries (such as a mixture of mineral bearing particles in water or dilute acid or alkali).

“Fluid flow paths” means the pathways by which reagent fluids flow in the sparge.

“Fluidized bed reactor” means a reactor that injects a liquid or gas through a granular material above a perforated distributor at sufficiently high velocity to make the granular material, above the distributor, behave like a fluid (hence fluidized) to increase the contact between the fluidizing fluid and the granular material to increase the rate of burning or combustion of the granular material within the reactor. Often bubble caps are fitted to the distributor to prevent flow of the granular material into the gas distributor and increase the speed of the injected liquid or gas to improve the mixing of the reaction fluids with the granular material and inhibit the flow of granular material back into the gas distributor.

Fluidized bed reactors are two phase devices and operate at atmospheric pressure (about 100 kPa or 1 bar) and high temperature.

“High energy” means sufficient energy to mix between 100 to 1000 tonnes of slurry in between 20 to 60 seconds.

“High pressure” means pressures up to about 6,000 kPa (60 bar), as commonly used in high pressure acid leach (HPAL), pressure acid leach (PAL) or pressure oxidation (PDX) autoclave processing operations. The present invention is concerned with high pressure vessels and is not applicable to fluidized bed reactors. Fluidized bed reactors cannot be operated at high pressure because such pressures are unsuitable, inappropriate and dangerous for the oxidization or combustion processes that fluidized bed reactors are designed for.

“High temperature” means greater than about 500° C., as is commonly used in fluidized bed reactors.

“Low pressure” means either atmospheric pressure (about 100 kPa or 1 bar) or up to about 200 kPa (2 bar), as commonly used in fluidized bed reactors.

“Reagents” means fluids injected by the sparge of the present invention into the high-pressure reaction vessel for increasing the speed of reaction or controlling process parameters. Typically, the reagents include oxygen, acid, alkali, water and steam, in liquid or gaseous phases.

“Slurry” means a mixture of solid, liquid and/or gas phases into a fluid like mixture having liquid like properties.

“Sparge” means a device, generally in the form of a pipe, used to inject a gas into a liquid or for injecting a gas or liquid into a slurry. In the context of the present invention sparge specifically refers to injection of a gas and/or a liquid into a fluid in the form of a slurry of ore bearing particles for feeding reactants, controlling process conditions such as temperature, pressure and process reaction rates. We note that some sources refer to a sparge as a sparger.

“Vessel” in the context of the present invention generally means a high-pressure reaction vessel, such as an autoclave.

### BACKGROUND OF THE INVENTION

High pressure autoclaves are used to aggressively leach minerals from ores and avoid the high energy needs of more traditional pyrometallurgical processes, such as smelting. These autoclaves are typically horizontally disposed and have a plurality of agitators, such as, for example, 4 to 12 agitators distributed along their length for stirring a mineral bearing slurry for reducing processing time. The agitators are high power mixer devices commonly needing around 400 kW of power to run and capable of turning over the entire contents of an autoclave (commonly 100 to 1000 tonnes) within about 20 to 60 seconds.

High pressure autoclaves sometimes have sparge pipes for injecting reactive gases, such as oxygen, or liquids, such as acid or alkalis or water, into the mineral bearing slurry, for further reducing reaction times and controlling process parameters such as temperature and pressure. In such arrangements one sparge pipe is commonly associated with each agitator. A common challenge for the use of sparge pipes, in high pressure autoclaves, is their tendency to fill up with, and become blocked by, slurry and solid materials during low injection flow rates and no flow operation (such as occurs during process or production holds). Unblocking of the sparge pipes is typically achieved by quench water or steam purging of the sparge pipes while the autoclave is online, although sometimes unblocking of the spare pipes requires the vessel to be depressurised and the sparge to be mechanically unblocked. Online purging to prevent blockages is effected by service valves which may have to be operated, in some installations, as often as 12 times per day to constantly flush settled slurry, broken refractory bricks and scale from the sparge pipes. This frequency of purging can quickly exceed the manufacturer's recommended number of valve actuations between service intervals. Such a high frequency of valve actuation means that the valves have been observed to exceed the recommended actuations in less than 20 days, where a typical autoclave campaign could last for 1 year or more. This adversely impacts the efficiency of operation of the autoclave and reduces profitability. Servicing of such valves is preferably performed between campaigns.

Another challenge of using sparge pipes in high pressure autoclaves is to avoid high flow rates that can cause metal materials of the pipe to either wear rapidly or even to combust and in the worst-case lead to loss of containment and violent and rapid depressurisation of the autoclave. Careful design is needed to maintain maximum fluid flow rates in high pressure autoclaves, typically below 20 m/s, to substantially reduce the risk of combustion of sparge pipe metal materials in the presence of high concentration oxygen. However, the critical velocity of reagent fluids in high concentration oxygen is pressure dependant, for example, at 5.6 MPa (56 bar) the critical impingement velocity of high purity oxygen is only 8 m/s.

In low pressure two phase chemical process plants, it is known to use bubble caps to distribute bubbles of a reactive gas into a solid particulate phase to be processed by distributing the gas to better contact and fluidise the solids. Bubble caps are usually in the form of a metal cup with notches or slots around its edge that is inverted over a pipe disposed in a hole in a plate in a fluidized bed reactor for effecting contact of gases rising from below the plate into a fluid, or granular solid, already on top of the plate. Typically, hundreds of bubble caps are used in the fluidized bed reactor to achieve the desired contact between the two phases. Such bubble caps are not known for use in high pressure vessels or autoclaves. As a low-pressure device, a bubble cap has the effect of providing a built-in solid seal which prevents backflow of reactor materials at low gas flow rates. Also, bubble caps are not known for use with agitators since fluidized bed reactors do not and cannot use agitators and autoclaves do not and generally cannot use fluid injectors to achieve agitation. Further, the materials processed within an autoclave could not normally be agitated by a bubble cap, since the energy of the injected fluid would not be sufficient to move the contents of the autoclave to achieve the required degree of mixing.

Bubble caps are not the equivalent of sparges. Bubble caps are two phase devices required for fluidized beds, whereas sparges are three phase devices required for high pressure autoclaves. Bubble caps strive to speed up the flow of fluids injected into low pressure reactors to agitate disperse and suspend particles in the reactor. Whereas the main purpose of sparges is to feed reagents into high pressure vessels and therefore sparges focus on reducing fluid speed to minimise wear and risk of combustion; and sparges rely upon high energy agitators to disburse the reagents and suspend slurry components.

Bubble caps have a low profile to provide maximum agitation at the bottom of the reactor, whereas sparges are relatively long (compared to its diameter) to distance the injected reagent fluids from the bottom of the vessel to reduce wear and localised temperature variations at the vessel walls.

A significant difference between high pressure autoclaves and fluidized bed reactors is that the former are fitted with high energy agitators (typically less than 12) that suspend the granular particles and disperse the gas injected, whereas in a fluidised bed reactor, the fluids, typically in the form of combustion gases, are injected using hundreds of high flow rate bubble caps to expand and suspend the bed of granular particles with gas. The solids and gas or liquid in the bed expand and flow with similar properties to those of a fluid, hence the name “fluidised bed reactor”. Also, autoclaves are designed to extract valuable minerals from ores, whereas fluidized bed reactors are designed to burn, hydrolyse or oxidize granular materials. Autoclaves must maintain relatively low fluid flow rates so as to avoid combustion and excessive wear, whereas fluidized bed reactors require high flow rates to maintain fluidization of granular materials for combustion purposes. Combustion is the enemy of autoclaves, whereas combustion is the goal of fluidized bed reactors. Accordingly, the technology of fluidized bed reactors is not applicable to the safe and efficient design and operation of autoclaves.

The problem of high pressure autoclaves is blockage of conventional sparge pipes caused by low or zero gas flow rates that commonly occur during normal operation. A previously untried solution to such blockage is to use a vapour lock means that prevents reaction chamber contents, most noticeably a slurry from flowing into the sparge during zero gas flow or low gas flow rates and which prevents solids from entering the sparge under the force of gravity. At low flow rates, the vapour lock means removes the requirement for a critical sparge fluid minimum exit velocity to prevent solids or slurry from entering the sparge under the force of gravity. Such vapour lock means must have no moving parts and be devoid of any kind of flow path that high-pressure fluids could traverse to avoid the vapour lock means and thereby defeat the vapour lock effect. A bubble cap bolted through a sparge pipe would produce such flow paths and hence would not be effective in serving as a vapour lock means.

Also, the vapour lock means must not provide a restriction that causes the velocity of the injected fluid to exceed the critical impingement velocity above which the metal materials of the sparge pipe combust in the presence of high purity oxygen or otherwise experience excessive wear. Typically, this velocity is about 20 m/s, for oxygen flows, although the critical velocity is dependent on the process fluids and operating conditions present in the autoclave. Bubble caps, by way of contrast, are usually designed to increase the speed of fluids flowing through them and pay no attention to limiting or reducing the velocity of the injected fluids.

In the present invention, a sparge is provided with a vapour lock means to substantially prevent the backflow of slurry and solid materials into the sparge when used in a high-pressure vessel, such as an autoclave.

### SUMMARY OF THE INVENTION

Therefore, it is an object of the present invention to provide a sparge with a vapour lock means to substantially prevent backflow of slurry materials into the sparge, in a high-pressure vessel during low or zero sparge fluid flow conditions.

In accordance with one aspect of the present invention, there is provided a sparge for use in a high-pressure vessel operated at elevated temperatures and having high energy agitators for suspending mineral containing particles in a slurry, the sparge injecting reagent fluids into the slurry to reduce reaction times and for controlling process parameters for extracting valuable minerals from the particles, the sparge comprising:

a pipe with its free end disposed within the high-pressure vessel proximate one of the agitators; and

a vapour lock means located about the free end of the pipe for substantially preventing backflow of slurry materials into the pipe during conditions of low or no fluid flow through the said pipe;

wherein the cross-sectional area of the pipe and the vapour lock means are configured to maintain reagent fluid flow rates below a critical impingement velocity above which excessive wear and combustion in the presence of high purity oxygen occur.

The vapour lock means may be fixedly or removably attached to the free end of the pipe or merely disposed about the free end of the pipe and being attachment elsewhere to the interior of the autoclave.

A diffusion ring or plate may be disposed proximate the outlet of the vapour lock means to ensure that the flow of dense fluid, such as cooling water, is directed radially away from the downwards direction of the exiting flow. The diffusion ring addresses the potential for localised cooling or high concentration of reagents at the bottom of the autoclave and aids dispersion to assist the reaction processes.

Where the autoclave includes agitators, one or two sparge are typically associated with and/or arranged proximate each agitator. More specifically, one sparge per service that is delivered into the autoclave since some services (such as oxygen and steam) are kept separate in some pressure vessel designs.

In accordance with another aspect of the present invention, there is provided a high-pressure vessel for extracting valuable minerals from mineral containing particles, the high-pressure vessel comprising:

a reaction chamber for containing a slurry of the mineral containing particles at high pressure and elevated temperature;

a plurality of agitators for stirring the slurry; and

at least one sparge for injecting reagent fluids into the slurry, each sparge being disposed proximate a respective one of the agitators, and the sparge comprising:

a pipe with its free end disposed within the reaction chamber; and

a vapour lock means located about the free end of the pipe for substantially preventing backflow of slurry materials into the pipe during conditions of low or no fluid flow through the said pipe.

In accordance with a further aspect of the present invention, there is provided a high pressure autoclave process for extracting valuable minerals from mineral containing particles in a reaction chamber having a plurality of agitators and at least one sparge associated with each agitator, the sparge comprising a pipe with its free end disposed within the reaction chamber and a vapour lock means located about the free end of the pipe for substantially preventing backflow of slurry materials into the pipe during conditions of low or no fluid flow through the said pipe, the process comprising the steps of:

filling the reaction vessel with a slurry of the mineral containing particles;

pressurising the reaction chamber to a high pressure;

mixing the slurry with agitators;

injecting reagent fluids into the reaction chamber with the sparges; and

blocking flow of said slurry materials from the reaction chamber into the pipe with the vapour lock means.

Typically, where corrosion and erosion of the sparge are prevalent, the sparge of the present invention may be provided with a protective coating over its entire wetted surface. For example, the sparge of the present invention may have a ceramic metal spray coating, or a sheath outer layer, or be clad along its wetted external surface with a material different to that of the sparge, to protect against the effects of corrosion and/or erosion otherwise caused by contact with corrosive and/or abrasive autoclave fluids.

Preferably, the sparge pipe extends a distance into the autoclave that is relatively long compared to its diameter.

In the context of the present invention “relatively long” with reference to the sparge pipe means that the portion of the sparge pipe residing within the autoclave is greater than about 300% of external diameter of the sparge pipe.

Typically, the sparge pipe has a relatively thick wall compared to its diameter. However, the sparge pipe could be made from relatively thin wall material.

In the context of the present invention “relatively thick” with reference to the wall of the sparge pipe has the meaning that the pipe wall is greater than about 10% of the radial dimension of the sparge pipe. Although, the pipe wall may be relatively thin.

Throughout the specification, unless the context requires otherwise, the word “comprise” or variations such as “comprises” or “comprising”, will be understood to imply the inclusion of a stated integer or group of integers but not the exclusion of any other integer or group of integers. Also, the word “preferably” or variations such as “preferred”, will be understood to imply that a stated integer or group of integers is desirable but not necessarily essential to the working of the invention.

### BRIEF DESCRIPTION OF THE DRAWING(S)

Exemplary embodiments of the present invention will now be described with reference to the accompanying drawing, in which:

FIGS. 1 to 6 are cross-sectional views of a portion of a conventional high-pressure autoclave showing prior art sparge configurations, for which exemplary embodiments of the present invention are shown in FIGS. 7 to 18, respectively;

FIGS. 1 and 2 are cross-sectional views of a portion of a conventional high-pressure autoclave with a prior art bottom entry sparge, FIG. 2 is shown at a smaller scale and showing the sparge in relation to an agitator;

FIG. 3 is a cross-sectional view of the prior art high pressure autoclave of FIG. 1 and FIG. 2 shown at a still smaller scale;

FIGS. 4 and 5 are cross-sectional views of two differing orientations of top entry prior art autoclave sparges. FIG. 4 shows a top entry sparge with a vertically up sparge pipe free/discharge end located beneath the agitator and FIG. 5 shows a top entry sparge with a horizontal sparge pipe free/discharge end located beneath the agitator;

FIG. 6 is a cross-sectional view of a side entry prior art sparge with a horizontal sparge pipe free/discharge end located above the agitator;

FIGS. 7 and 8 are cross-sectional end views of a portion of a high-pressure autoclave with a bottom entry sparge in accordance with one embodiment of the present invention. FIG. 8 is shown at a smaller scale and showing the sparge in relation to an agitator and showing a vapour lock means mounted on a sparge pipe;

FIG. 9 is a cross-sectional end view of the high-pressure autoclave of FIGS. 7 and 8 shown at a still smaller scale;

FIG. 10 is a cross-sectional side view of the sparge of FIG. 7 shown in isolation;

FIGS. 11 and 12 are cross-sectional end views of a portion of a high-pressure autoclave with a bottom entry sparge in accordance with another embodiment the present invention,

FIG. 12 is shown at a smaller scale and showing the sparge in relation to an agitator and showing a vapour lock means mounted on the agitator;

FIG. 13 is a cross-sectional end view of the high-pressure autoclave of FIGS. 11 and 12 shown at a still smaller scale;

FIG. 14 is a cross-sectional end view of a portion of a high-pressure autoclave with a top entry sparge in accordance with still another embodiment of the present invention;

FIG. 15 is a cross-sectional end view of the high-pressure autoclave of FIG. 14 shown at a smaller scale;

FIG. 16 is a cross-sectional end view of a portion of a high-pressure autoclave with a side entry sparge in accordance with yet another embodiment of the present invention;

FIG. 17 is cross-sectional end view of the high-pressure autoclave of FIG. 16 shown at a smaller scale;

FIG. 18 is an end perspective view of one cell of a high-pressure autoclave shown with the bottom entry sparge of FIG. 7 shown in relation to an agitator; and

FIG. 19 is a perspective view, seen from above, of a high-pressure autoclave having 6 cells and one sparge of the present invention associated with each cell.

### PRIOR ART

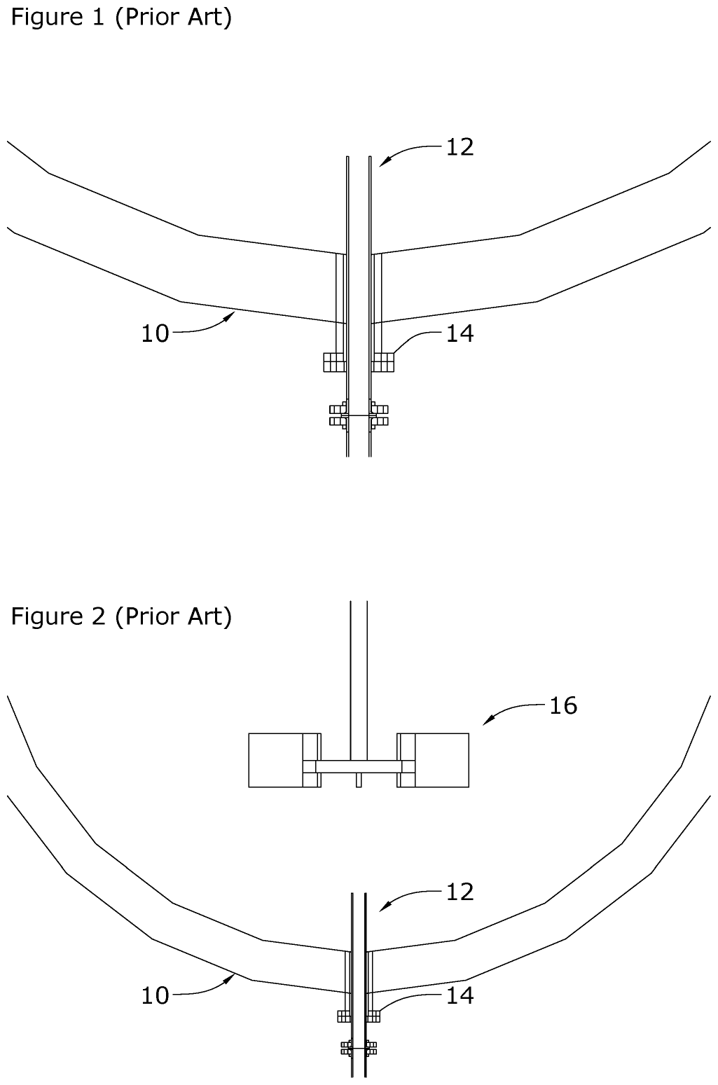

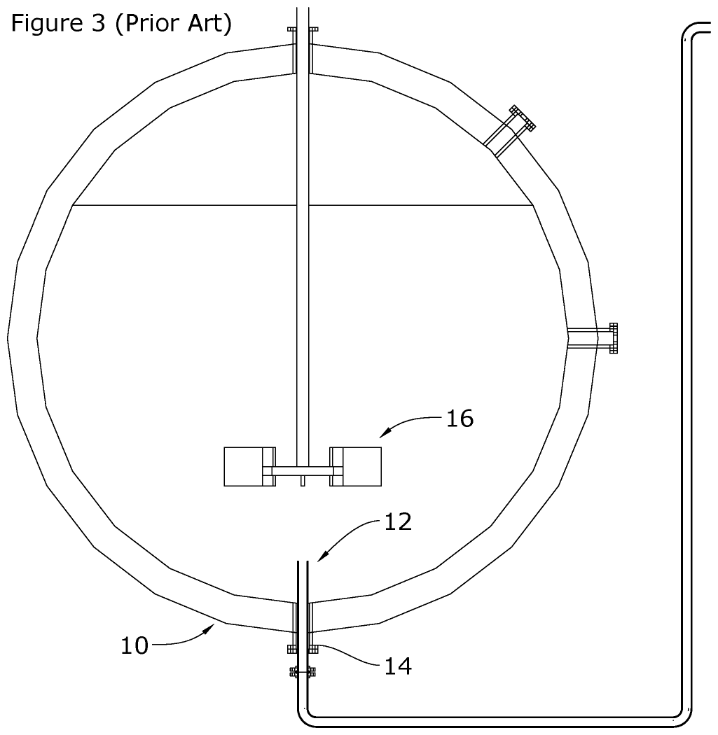

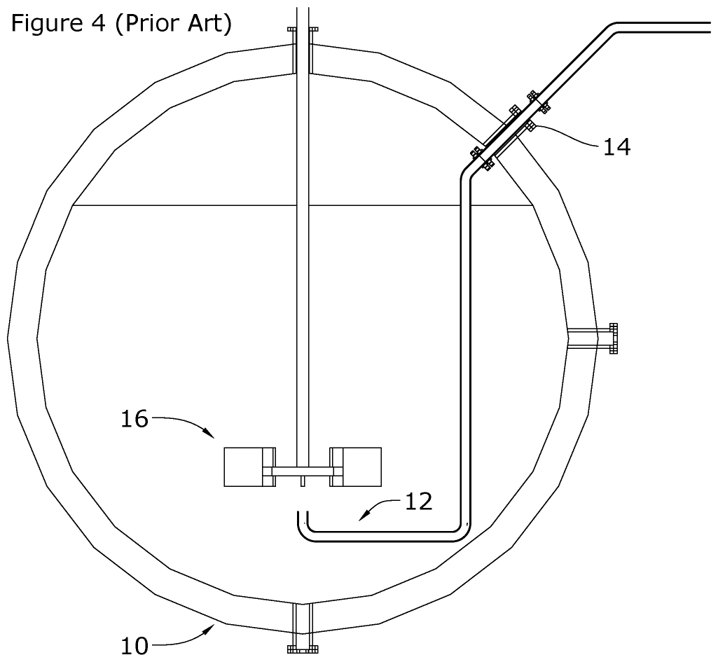

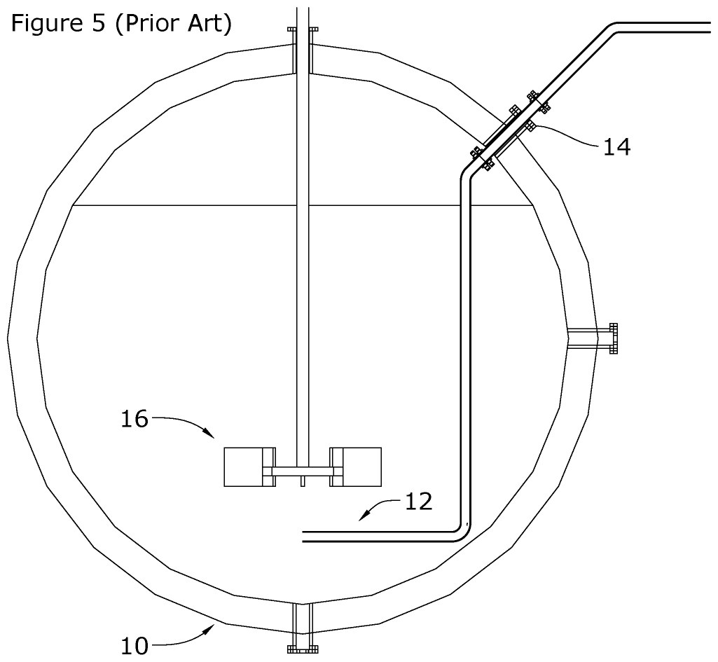

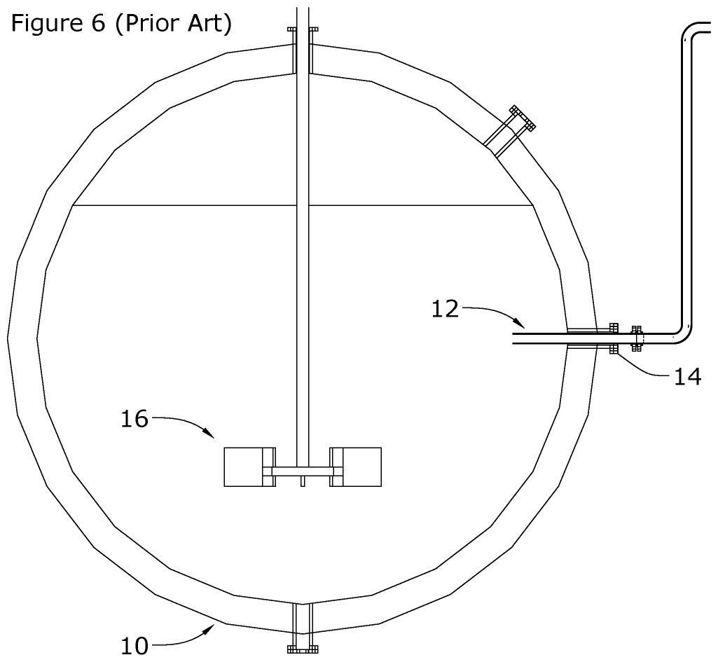

In FIGS. 1 to 3 there is shown a high-pressure vessel in the form of a high-pressure autoclave 10 with a conventional bottom entry sparge 12 installed in a flange 14 of the autoclave commonly known in the art. The autoclave 10 also typically has an agitator 16 for stirring a slurry comprising mineral bearing ore and a reagent liquid (typically a strong acid). The autoclave 10 typically has 4-8 cells (in similar manner to the six cells shown in FIG. 19), each with one sparge 12 and one agitator 16. The sparge 12 has the limitation that it is prone to blockage with slurry materials when the flow of fluid into the autoclave 10 via the sparge 12 is low or ceases.

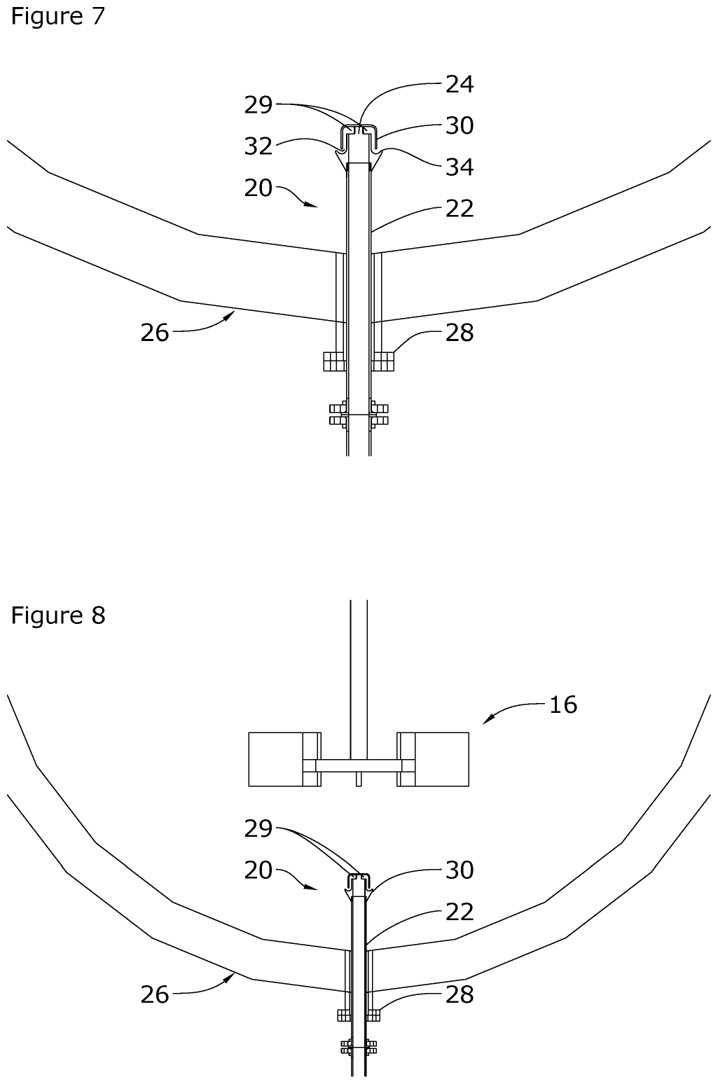

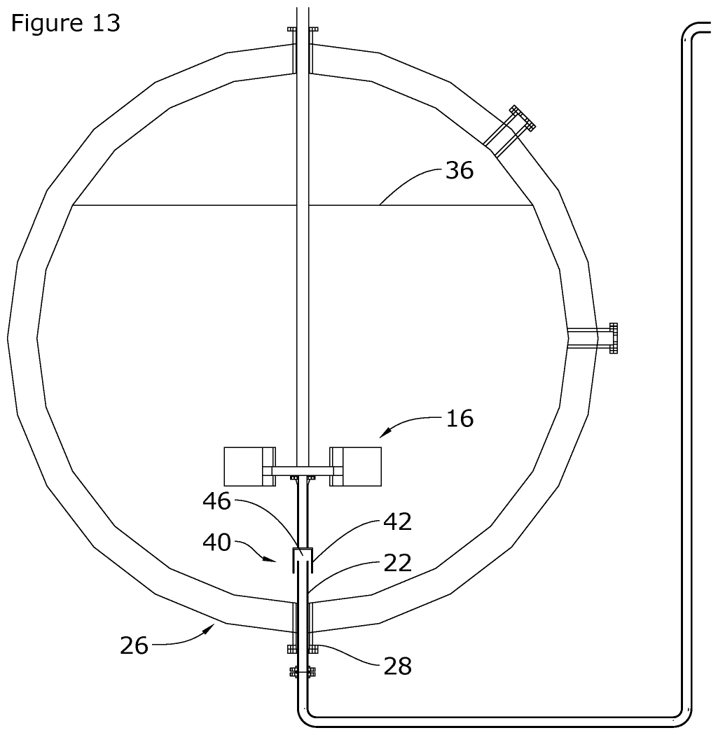

FIGS. 7 to 17 show sparges 20, 40, 60 and 80, in accordance with several embodiments of the present invention each of which have the advantage that backflow of slurry materials into a sparge pipe is inhibited by the use of a vapour lock means. Each embodiment shall now be described in some detail, and like numerals denote like parts.

### DETAILED DESCRIPTION OF PREFERRED EMBODIMENTS

In FIGS. 7 to 9 there is shown a bottom entry sparge 20 comprising a sparge pipe 22 with a free end 24 disposed within a high-pressure autoclave 26 through a flange 28. The sparge 20 also comprises apertures 29, located in the end of the sparge pipe 22 and about which is disposed an overhung, inverted cap 30. The inverted cap 30 is disposed facing downwardly such that mineral bearing particles under agitation in the autoclave 26 cannot settle or fall under the force of gravity into the sparge pipe 22. The inverted cap 30 forms an annular outlet 32 with the free end 24 of the sparge pipe 22.

The sparge pipe 22 could be disposed into the autoclave 26 from below, to the side or from above the agitator 16, provided the fluids exiting the sparge pipe 22 are proximate one of the agitators 16 and distributable via the agitators 16 to increase the speed of process reactions or the desired process conditions change. To ensure that a vapour lock is achieved, it is essential that the outlet 32 be oriented such that mineral bearing material and refractory brick detritus materials cannot fall or settle under the action of gravity into the sparge pipe 22.

Preferably, the cross-sectional area of the apertures 29 is greater than the cross-sectional area of the inside of the sparge pipe 22, so as to prevent an increase in velocity of fluids flowing into the autoclave 26 via the sparge 20.

Typically, the autoclave 26 is generally cylindrical with domed ends. Typically, the autoclave 26 is disposed substantially horizontally, although it could be disposed vertically.

Typically, the autoclave 26 is lined with refractory bricks or a metal alloy that is chemically resistant, to protect the metal outer layer of the autoclave 26 from the temperatures and corrosive materials contained within the autoclave 26 when in operation.

Conveniently the sparge 20 also has a diffusion ring or plate 34 disposed about the pipe 22 at the outlet 32 to ensure that the flow of denser fluids, such as cooling water, out of the sparge 20 are directed radially away from the pipe 22 rather than axially downward along the pipe 22. The diffusion ring 34 addresses the potential for localised cooling or high concentrations of reagents at the bottom of the autoclave 26 and aids dispersion to assist mixing and reaction processes.

Conveniently, the sparge 20 may have a protective coating over some or all of its wetted external surface. For example, the sparge 20 may have a ceramic metal spray coating, or a sheath outer layer or be clad to protect against the effects of corrosion and/or erosion otherwise caused by contact with corrosive and/or abrasive autoclave fluids entering via the sparge pipe 22.

Preferably, the annular outlet 32 is greater in cross sectional area than the cross-sectional area of the apertures 29—so as to prevent an increase in velocity of fluids flowing into the autoclave 26 via the sparge 20.

The free end 24, the apertures 29, the inverted cap 30 and the annular outlet 32 together constitute the vapour lock means of the present invention in this bottom entry configuration embodiment. The vapour lock is created when the flow of sparge fluids out of the outlet 32 ceases. Under such conditions the pressure of the fluids within the sparge pipe 22 are the same as the pressure of the fluids within the autoclave 26. Accordingly, there can be no fluid flow back into the sparge pipe 22. Also, there can be no flow of particles under the force of gravity since the apertures 29 are above the annular outlet 32.

FIG. 10 shows the vapour lock means of the present invention to a larger scale. The vapour lock means is constituted by the free end 24 of the sparge pipe 22, the apertures 29, the inverted cap 30 and the annular outlet 32 formed between the inverted cap 30 and the diffusion ring 34. The cross-sectional area of the annular outlet 32 is greater than the cross-sectional area of the apertures 29, which are in turn greater than the cross-sectional area of the sparge pipe 22.

The inverted cap 30 is conveniently threadedly attached to the end 24 of the sparge pipe 22. It is essential that the thread be of such a length and pitch that fluids cannot flow along the thread between the inverted cap 30 and the end 24, as such flow would permit slurry to enter into and block the sparge 20 and this would compromise the vapour lock means.

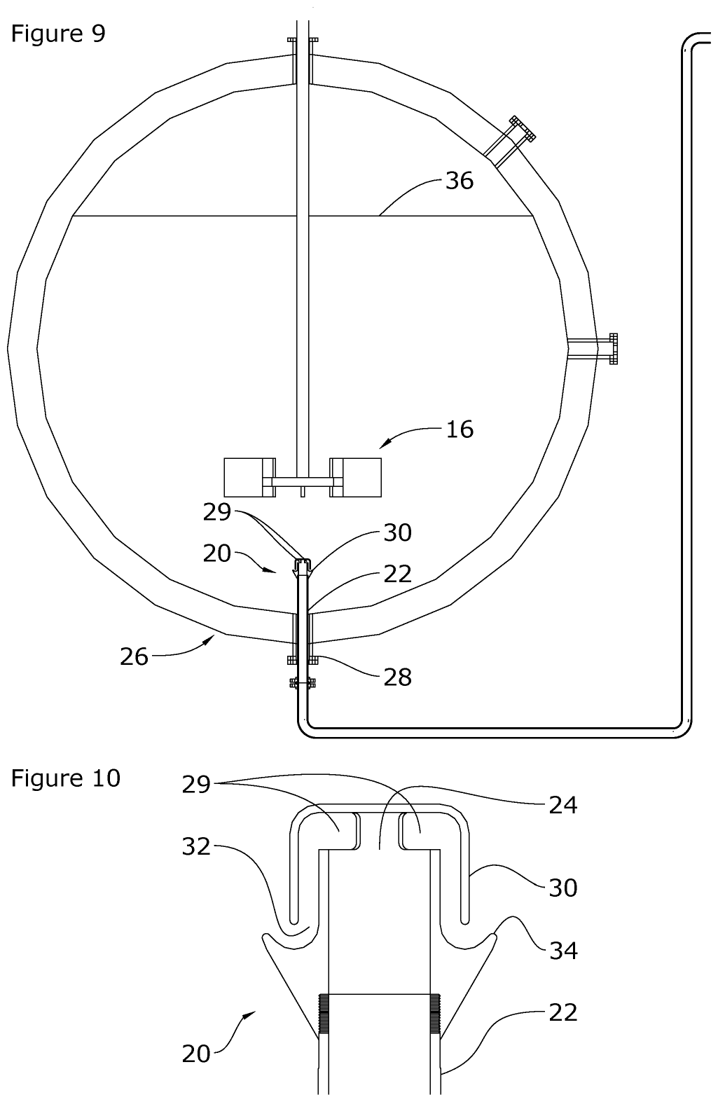

In FIGS. 9, 13, 15 and 17 the typical level of slurry contained within the autoclave 26 is shown and denoted with numeral 36 and referred to as the slurry level 36.

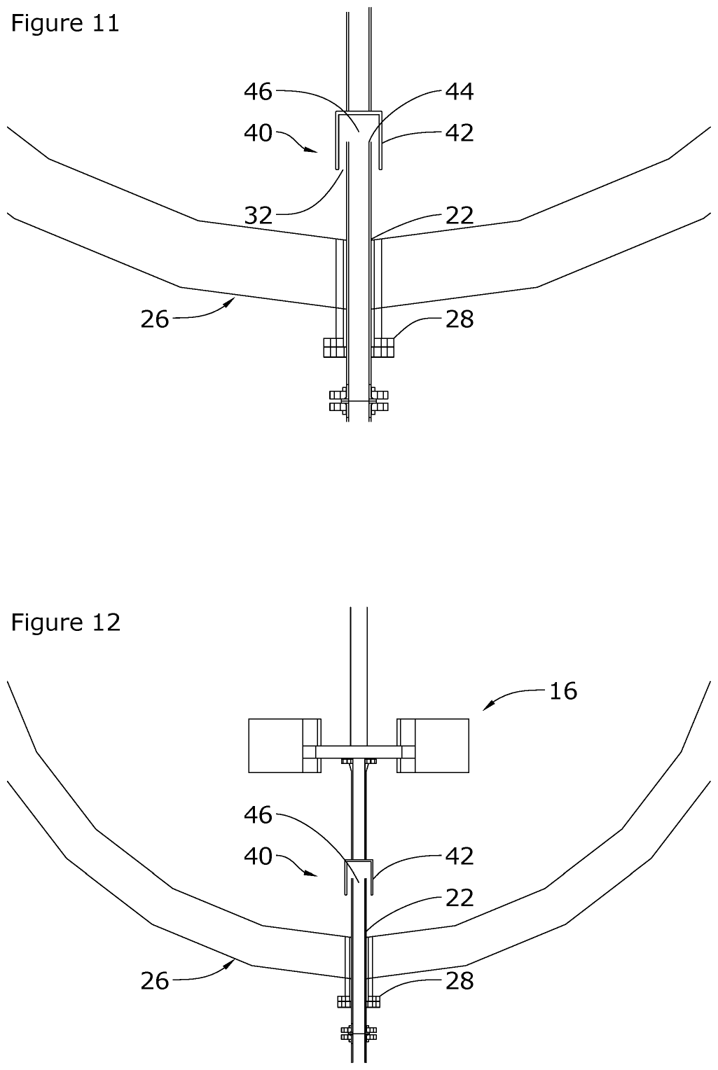

In FIGS. 11 to 13 there is shown a bottom entry sparge 40, which is similar to the bottom entry sparge 20, with like numerals denoting like parts.

The sparge 40 differs from the sparge 20 in that the sparge 40 has an overhung inverted cap 42 mounted onto the agitator 16 and disposed about a free end 44 of the sparge pipe 22 to form the outlet 32. In this manner, the inverted cap 42 rotates with the agitator 16 and is not attached in any way to the sparge pipe 22. Also, the free end 44 of the sparge pipe 22 includes only a single aperture 46, although multiple apertures akin to the apertures 29 could be provided.

The free end 44, the aperture 46, the inverted cap 42 and the annular outlet 32 together constitute the vapour lock means of the present invention. The vapour lock is created when the flow of sparge fluids out of the outlet 32 ceases. Under such conditions the pressure of the fluids within the sparge pipe 22 are the same as the pressure of the fluids within the autoclave 26. Accordingly, there can be no fluid flow back into the sparge pipe 22. Also, there can be no flow of particles under the force of gravity since the aperture 46 is above the annular outlet 32.

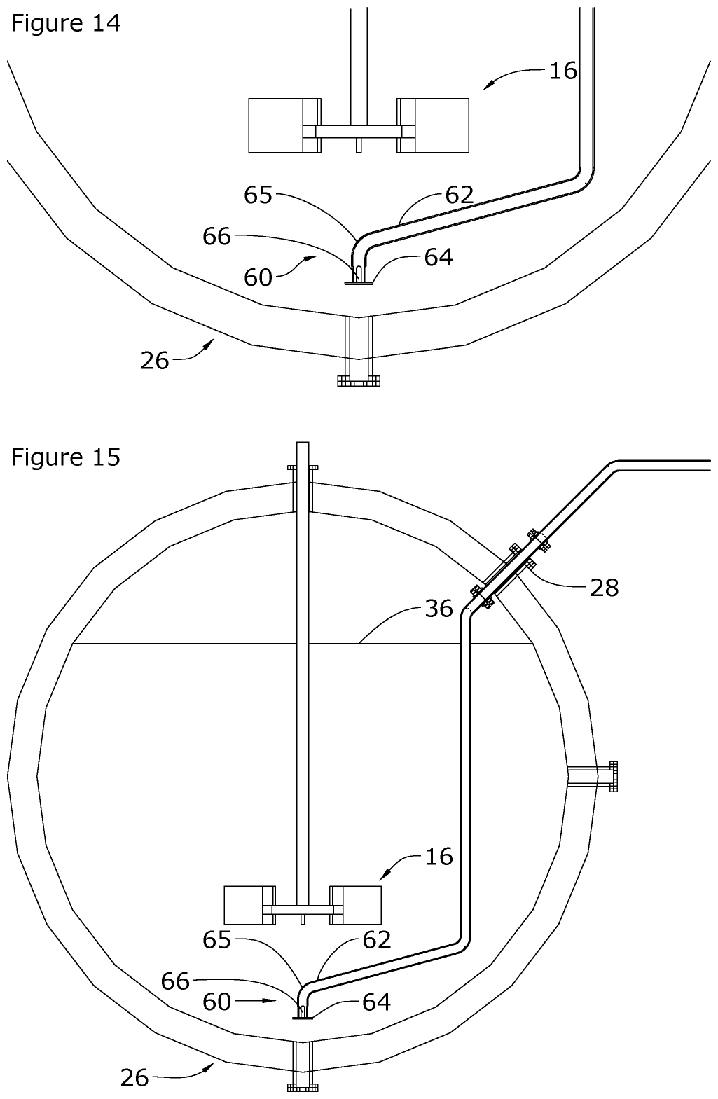

In FIGS. 14 and 15 there is shown a top entry sparge 60, which is similar the sparge 20, with like numerals denoting like parts.

The sparge 60 differs from the sparge 20 in that the sparge 60 does not have an inverted cap. The sparge 60 has a sparge pipe 62 which enters the autoclave 26 from above or to the side of the agitator 16 and terminates at an end plate 64 which is disposed downwardly. The sparge pipe 62 differs from the sparge pipe 22 in that it has an elbow 65 proximate its free end. The sparge pipe 62 has apertures 66, conveniently in the form of flutes, disposed above the end plate 64. The cross-sectional area of the apertures 66 is preferably greater than the cross-sectional area of the sparge pipe 62 so as to avoid increasing the speed of the fluids delivered by the sparge pipe 62 into the autoclave 26. The end plate 64 is equivalent to the diffusion ring 34.

The sparge 60 also differs from the sparge 20 in that it does not have an annular outlet. In this embodiment, the apertures 66 form an outlet for the flow of sparge fluids. Also, the apertures 66 are disposed so that mineral bearing material and refractory brick detritus materials cannot fall under the action of gravity into the sparge pipe 62.

The sparge pipe 62 could be disposed into the autoclave 26 from the side or from above the agitator 16, provided the fluids exiting the sparge pipe 62 are proximate one of the agitators 16 and distributable via the agitators 16 to increase the speed of process reactions. Also, it is essential that the outlet 32 be directed downwardly so that mineral bearing material and refractory brick detritus materials cannot fall under the action of gravity into the sparge pipe 22.

The end plate 64, the elbow 65 and the apertures 66 together constitute the vapour lock means of the present invention. The vapour lock is created when the flow of sparge fluids out of the apertures 66 ceases. Under such conditions the pressure of the fluids within the sparge pipe 62 are the same as the pressure of the fluids within the autoclave 26. Accordingly, there can be no fluid flow back into the sparge pipe 62. Also, there can be no flow of particles under the force of gravity since the apertures 66 are below the level of the elbow 65 and the rest of the sparge pipe 62.

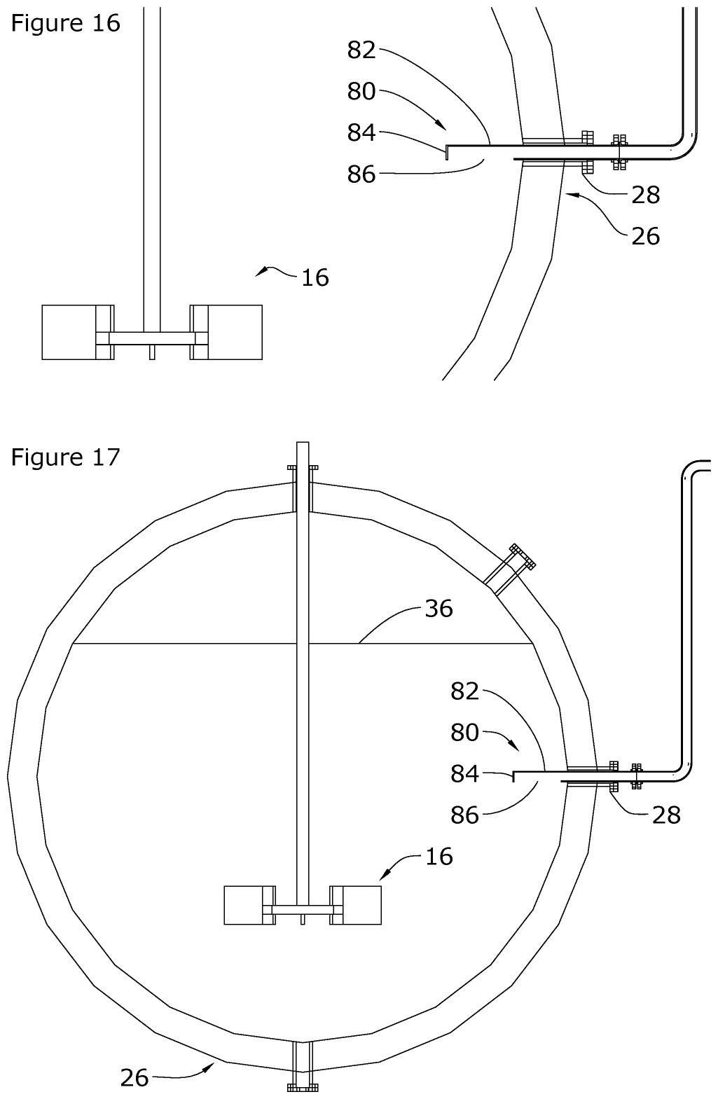

In FIGS. 16 and 17 there is shown a side entry sparge 80, which is similar to the sparge 20, with like numerals denoting like parts.

The sparge 80 differs from the sparge 20 in that it has a sparge pipe 82 disposed substantially horizontally into the autoclave 26. The sparge pipe 82 terminates at a blank end 84. The sparge pipe 82 also has an opening 86 in its lower extent for the egress of sparge fluids. The opening 86 is disposed to inhibit the ingress of mineral bearing material and refractory brick detritus materials falling under the action of gravity into the sparge pipe 82.

The blank end 84 and the opening 86 together constitute the vapour lock means of the present invention. The vapour lock is created when the flow of sparge fluids out of the opening 86 ceases. Under such conditions the pressure of the fluids within the sparge pipe 82 are the same as the pressure of the fluids within the autoclave 26. Accordingly, there can be no fluid flow back into the sparge pipe 82. Also, there can be no flow of particles under the force of gravity since the opening 86 is disposed downwardly and below the level of the remainder of the sparge pipe 82.

Conveniently, like the sparge 20, the sparges 40, 60 and 80 can have a protective coating over its entire wetted external surface. For example, the sparges 40, 60 and 80 may have a ceramic metal spray coating, or a sheath outer layer or be clad to protect against the effects of corrosion and/or erosion otherwise caused by contact with corrosive and/or abrasive autoclave fluids entering via the sparge pipe 22.

The sparges 40 and 60 could be provided with a diffusion ring or plate, similar to the diffusion ring 34 of the sparge 20.

Preferably, the sparge pipe 22 extends a distance into the autoclave 26 that is relatively long length compared to its diameter.

In the context of the present invention “relatively long” with reference to the sparge pipe 22 means that the portion of the sparge pipe 22 residing within the autoclave 26 is greater than about 300% of external diameter of the sparge pipe 22.

Typically, the sparge pipe 22 has a relatively thick wall compared to its diameter. However, the sparge pipe 22 could be made from relatively thin wall material.

In the context of the present invention “relatively thick” with reference to the wall of the pipe means that the pipe wall is greater than about 10% of the radial dimension of the pipe.

Typically, the sparge pipe 22 is made from stainless steel metals, chemically resistant alloy materials (such as tantalum) or the like.

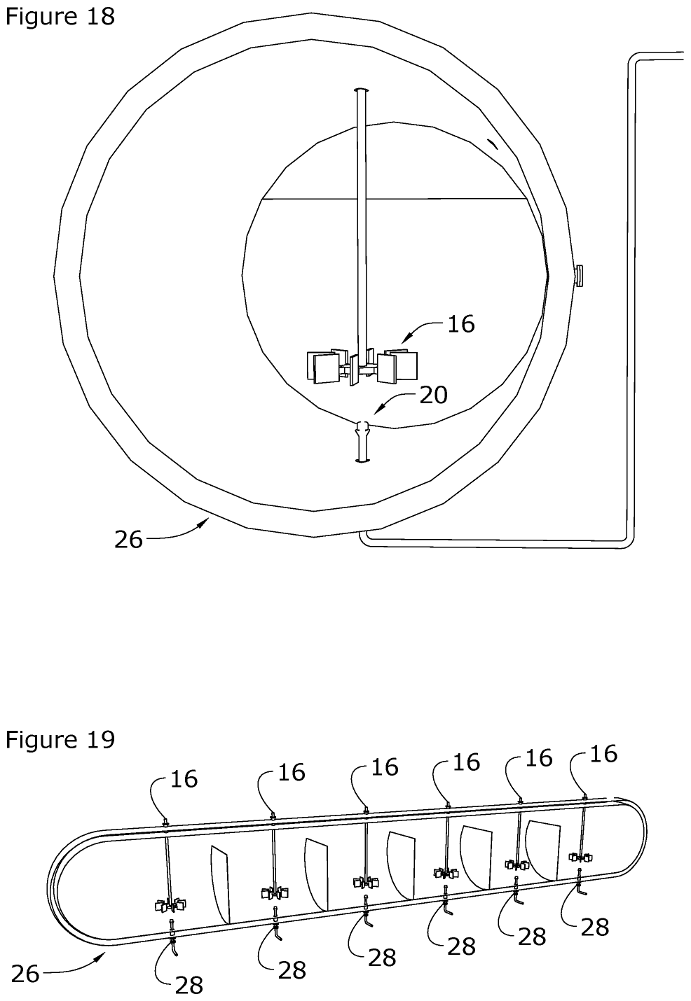

The autoclave 26, fitted with six of the sparges 20 of the present invention, is shown in FIG. 19. A single cell of the autoclave 26 is shown in FIG. 18. The autoclave 26 may be of generally conventional design and construction in the accommodation of the sparge 20, 40, 60, 80. Typically, there is one sparge 20, 40, 60 or 80 per cell, although there could be two or a few sparges 20, 40, 60 or 80 per cell. However, typically, there is only one agitator 16 per cell.

In relation to the vapour lock means it is preferred that the cross sectional area increases from that of the sparge pipe 22, 62 and 82 to the outlet 32, the apertures 66 and the opening 86 respectively so as to reduce the velocity of the sparge fluids entering into the autoclave 26 and reduce the risk of combustion of the sparge pipe 22, 62 and 82. The increase in cross sectional area has the effect of ensuring that velocity of sparge fluids is kept below a critical impingement velocity of approximately 20 m/s—above which critical velocity, with other conducive factors, oxygen or other flammable fluids injected into the autoclave 26 may cause combustion of the metal (such as titanium, stainless steel and some alloys) of the sparge pipes 22, 62 and 82 and the vapour lock means.

That is to say, it is preferred that the cross sectional areas of the sparge pipe 22, 62 and 82 and the vapour lock means increase in the direction of flow of the reagent fluids so as to avoid high flow rates that can cause metal materials of the pipe to either wear rapidly or even to combust and in the worst case lead to loss of containment and violent and rapid depressurisation of the autoclave 26. Careful design is used to maintain maximum fluid flow rates in high pressure autoclaves, typically below 20 m/s, to substantially reduce the risk of combustion of sparge pipe metal materials in the presence of high concentration oxygen and typical pressures. However, the critical velocity of reagent fluids in high concentration oxygen is pressure dependant, for example at 5.6 MPa (56 bar) the critical impingement velocity of high concentration oxygen is only 8 m/s.

Preferably, the cross-sectional area of the sparge pipe 22, 62 and 82 and the vapour lock means generally increases in the direction of flow of the reagent fluids being injected into the autoclave 26.

Preferably, the cross-sectional area of the vapour lock means is at least 100% larger than the cross-sectional area of the sparge pipe 22, 62 and 82.

More preferably, the cross-sectional area of the vapour lock means is at least 200% larger than the cross-sectional area of the sparge pipe 22, 62, 82.

It is important that there be no flow path into the sparge pipe 22, 62 and 82 upstream of the vapour lock means. This is because any joins that form part of the sparge 20,40,60,80 or the vapour lock means produce a potential flow path for high pressure fluids from inside the autoclave 26 to inside the sparge pipe 22, 62 and 82. Accordingly, bolting through the sparge pipe 22, 62 and 82 is not permitted. Any joins that form part of the sparge or vapour lock means must be sufficient so as to ensure that fluid cannot bypass through the wall of the sparge pipe 22, 62 and 82 directly to or from the autoclave 26.

### USE

In use, the sparge 20, 40, 60 or 80 is installed into the autoclave 26 via the flange 28. The flange 28 provides a seal with the sparge pipe 22, 62 and 82 and prevents high pressure fluids escaping the autoclave 26.

The sparges 20 and 60 are installed into the flange 28 from inside the autoclave 26. Whereas, the sparges 40 and 80 can be inserted into the autoclave 26 through the flange 28 from outside the autoclave 26.

Under normal sparge operation of the bottom entry sparge 20, sparge fluids flow upwardly through the sparge pipe 22 out of the end 24 of the sparge pipe 22, through the apertures 29, and out of the inverted cap 30 through the outlet 32 and into the autoclave 26 proximate the diffusion ring 34. The diffusion ring 34 serves to direct higher density sparge fluids, such as water, away from the sparge pipe 22. The agitator 16 then mixes the sparge fluids throughout the slurry 36 to increase the speed of reaction or control production processes.

For the bottom entry sparge 40, sparge fluids flow upwardly through the sparge pipe 22 out of the free end 44, into the inverted cap 42, out of the outlet 32 and into the autoclave 26 as the inverted cap 42 rotates with the agitator 16. The agitator 16 then mixes the sparge fluids throughout the slurry 36.

For the top entry sparge 60, sparge fluids flow downwardly through the sparge pipe 62, impinge against the end plate 64, flow out of the apertures 66 and into the autoclave 26 proximate the agitator 16, which then mixes the sparge fluids throughout the slurry 36.

For the side entry sparge 80, sparge fluids flow through the sparge pipe 82 and out of the opening 86 and into the autoclave 26.

The sparge fluids may be dilute acid or dilute alkali, water, steam or a gas such as oxygen, for example. The sparge fluids must not be permitted to combust or cause any material within the autoclave 26 to combust—otherwise the autoclave 26 has the potential to explode.

In each embodiment of the present invention, during low or no flow of sparge fluid, the pressure within the sparge pipes 22, 62 and 82 is the same as the pressure inside the autoclave 26 and hence a vapour lock is achieved preventing backflow of fluid from the autoclave 26 into the sparge pipes 22, 62 and 82.

Also, because of the disposition and orientation of the outlets 32, the apertures 66 and the openings 86 particulate materials within the autoclave 26 cannot fall under the force of gravity into the sparge pipes 22, 62 and 82, thus substantially preventing blockage of the sparge pipes 22, 62 and 82.

### INDUSTRIAL APPLICABILITY

The sparge 20, 40, 60, 80 of the present invention is suitable for use in increasing the rate of reaction processes within a high-pressure vessel such as an autoclave for the recovery of valuable minerals from ore without the use of pyrometallurgical methods and processes.

The sparge 20, 40, 60, 80 of the present invention resides and operates in the fields of high pressure mineral processing via autoclaves and elevated temperature for the recovery of valuable minerals from ore.

The consequence of the use of the sparge 20, 40, 60, 80 of the present invention is that reagent fluids can be injected into the autoclave without the risk of the sparge pipe 22, 62 and 82 becoming blocked with slurry or detritus material even under low or no flow conditions, thus avoiding downtime otherwise required to clear prior art sparge pipes used in autoclaves.

Also, the sparge 20, 40, 60, 80 of the present invention is designed to slow the flow of reagent fluids into the autoclave 26 to reduce the risk of combustion or wear of the metals materials used to make the sparge 20, 40, 60, 80.

### REFERENCE SIGNS

The specification uses the following reference signs:

### PRIOR ART

10 high-pressure autoclave

12 sparge

14 flange

16 agitator

### PRESENT INVENTION

20 bottom entry sparge

22 sparge pipe

24 free end—sparge pipe

26 autoclave

28 flange

29 apertures

30 inverted cap

32 annular outlet

34 diffusion ring

36 slurry level

40 bottom entry sparge

42 inverted cap

44 free end—sparge pipe

46 aperture

60 top entry sparge

62 sparge pipe

64 end plate

65 elbow

66 apertures

80 side entry sparge

82 sparge pipe

84 blank end

86 opening

### VAPOUR LOCK MEANS

The free end 24, the apertures 29, the inverted cap 30 and the annular outlet 32 together constitute the vapour lock means of the bottom entry sparge 20 embodiment of the present invention with the inverted cap 30 mounted onto the sparge pipe 22.

The free end 44, the aperture 46, the inverted cap 42 and the annular outlet 32 together constitute the vapour lock means of the bottom entry sparge embodiment of the present invention with the inverted cap 42 mounted onto the agitator 16.

The end plate 64, the elbow 65 and the apertures 66 together constitute the vapour lock means of the top entry sparge 60 embodiment of the present invention with the sparge pipe 62 entering via the upper reaches of the autoclave 26 above the agitator 16.

The blank end 84 and the opening 86 together constitute vapour lock means of the present invention with the side entry sparge pipe 82.

### ADVANTAGES

The sparges 20, 40, 60 and 80 of the present invention have the advantage that they include a vapour lock means which inhibits the backflow of particulate material and detritus material under low or no fluid flow situations which occur commonly in the operation of a high-pressure autoclave 26.

The sparges 40 and 80 have the added advantage that they can be removed and serviced without entering the autoclave 26.

The sparge 20, 40, 60, 80 has the added advantage that its fluid flow passages increase in cross sectional area in the direction of flow of reagent fluids so as to maintain the velocity of the reagent fluids below a critical impingement velocity above which materials of the pipe 22, 62 and 82 and the vapour lock means are likely to combust in the presence of high purity oxygen or experience excessive wear.

The coating of the sparges 20, 40, 60 and 80 has the further advantage of reducing wear upon their wetted external surface and increasing the interval between servicing of the sparges 20, 40, 60 and 80.

The sparge 20, 40, 60, 80 has the further advantage that there are no fluid flow paths through the wall of the sparge pipe 22 or the walls of the vapour lock.

The diffusion ring 34 and plate 64 have the advantage of directing exiting sparge fluids away from the spare pipe 22 and the bottom of the autoclave 26 and prolonging the operational life of the sparges 20 and 40 and the autoclave 26. The ring 34 and 64 is more typically beneficial where high density fluids, such as liquids, are used. The ring 34 and 64 is not very beneficial where only very low-density fluids, such as gas or steam, are used. This is because the buoyant force of the very low-density fluid is dominant over the relatively small downward momentum that the exiting fluid has.

### MODIFICATIONS AND VARIATIONS

It will be readily apparent to persons skilled in the relevant arts that various modifications and improvements may be made to the foregoing embodiments, in addition to those already described, without departing from the basic inventive concepts of the present invention. For example, other forms of protective coating could be used. Also, other sparge configurations, that maintain the vapour lock principle, could be used. Further, whilst the outlet 34 of the sparge is typically shown and described an annular, it could also be other shapes, such as, for example, flute shaped as shown as the flutes 66.

1. A sparge for use in a high-pressure vessel operated at elevated temperatures and having high energy agitators for suspending mineral containing particles in a slurry, the sparge injecting reagent fluids into the slurry to reduce reaction times and for controlling process parameters for extracting valuable minerals from the particles, the sparge comprising:
a pipe with its free end disposed within the high-pressure vessel proximate one of the agitators; and
a vapour lock means located about the free end of the pipe for substantially preventing backflow of slurry materials into the pipe during conditions of low or no fluid flow through the said pipe;
wherein the cross-sectional area of the pipe and the vapour lock means are configured to maintain reagent fluid flow rates below a critical impingement velocity above which excessive wear and combustion in the presence of high purity oxygen occur.

2. The sparge of claim 1, in which the vapour lock means has fluid flow paths dimensioned to maintain the velocity of the fluids injected into the high-pressure vessel to below a critical impingement velocity above which materials of the pipe and the vapour lock means are likely to combust in the presence of high purity oxygen or experience excessive wear.

3. The sparge of claim 1, in which the pipe has fluid flow paths dimensioned to maintain the rate of flow of the reagent fluids injected into the high-pressure vessel to below a critical impingement velocity above which materials of the pipe and the vapour lock means are likely to combust in the presence of high purity oxygen or experience excessive wear.

4. The sparge of claim 1, in which the pipe and the vapour lock means have fluid flow paths dimensioned to maintain the rate of flow of the reagent fluids injected into the high-pressure vessel to below a critical impingement velocity above which materials of the pipe and the vapour lock means are likely to combust in the presence of high purity oxygen or experience excessive wear.

5. The sparge of claim 1, in which the cross-sectional area of the pipe is less than the cross-sectional dimension of the vapour lock means.

6. The sparge of claim 1, in which the cross-sectional area of the pipe and the vapour lock means increase in the direction of flow of the injected reagent fluids, and the cross-sectional dimensions of the vapour lock means are greater than the cross-sectional dimensions of the pipe.

7. The sparge of claim 1, in which the cross-sectional area of the vapour lock means is at least about 200% of the cross-sectional area of the pipe.

8. The sparge of claim 1, in which the vapour lock means is disposed about the free end of the pipe and capable of rotational movement with respect to the said pipe, the vapour lock means being attachment to the interior of the autoclave.

9. The sparge of claim 1, in which the vapour lock means is attached to the pipe.

10. The sparge of claim 9, in which the vapour lock means is fixedly attached to the free end of the pipe or merely disposed about the free end of the pipe and being attachment elsewhere to the interior of the autoclave.

11. The sparge of claim 9, in which the vapour lock means is removably attached to the free end of the pipe.

12. The sparge of claim 1, also comprising a diffusion ring disposed proximate the outlet of the vapour lock means to direct flow of dense fluid radially away from the downwards direction of the exiting fluid flow.

13. The sparge of claim 1, in which a protective coating is applied to the entire wetted surface of the pipe and the vapour lock means.

14. The sparge of claim 13, in which the coating is chosen from one of ceramic metal spray coating, a sheath outer layer and a cladding with a material dissimilar to that of the pipe and the vapour lock means.

15. The sparge of claim 1, in which the sparge pipe is relatively long compared to its diameter.

16. The sparge of claim 15, in which the length of the portion of the sparge pipe residing within the autoclave is greater than about 300% of external diameter of the sparge pipe.

17. The sparge of claim 1, in which the sparge pipe has a relatively thick wall compared to its diameter.

17. sparge of claim 17, in which the thickness of the wall of the sparge pipe is greater than about 10% of the radial dimension of the sparge pipe.

19. A high-pressure vessel for extracting valuable minerals from mineral containing particles, the high-pressure vessel comprising:
a reaction chamber for containing a slurry of the mineral containing particles at high pressure and elevated temperature;
a plurality of agitators for stirring the slurry; and
at least one sparge for injecting reagent fluids into the slurry, each sparge being disposed proximate a respective one of the agitators, and the sparge comprising:
a pipe with its free end disposed within the reaction chamber; and
a vapour lock means located about the free end of the pipe for substantially preventing backflow of slurry materials into the pipe during conditions of low or no fluid flow through the said pipe.

20. A high pressure autoclave process for extracting valuable minerals from mineral containing particles in a reaction chamber having a plurality of agitators and at least one sparge associated with each agitator, the sparge comprising a pipe with its free end disposed within the reaction chamber and a vapour lock means located about the free end of the pipe for substantially preventing backflow of slurry materials into the pipe during conditions of low or no fluid flow through the said pipe, the process comprising the steps of:
filling the reaction vessel with a slurry of the mineral containing particles;
pressurising the reaction chamber to a high pressure;
mixing the slurry with agitators;
injecting reagent fluids into the reaction chamber with the sparges; and
blocking flow of said slurry materials from the reaction chamber into the pipe with the vapour lock means.
